(19) United States
(12) Patent Application Publication
(10) Pub. No.: US 2004/0127272 A1
(43) Pub. Date: Jul. 1, 2004

(54) System and method for virtual game

(76) Inventors: Chan-Jong Park, Daejeon (KR); Sang-Hun Oh, Jeonbuk (KR)

Correspondence Address: STAAS & HALSEY LLP, SUITE 700, 1201 NEW YORK AVENUE, N.W., WASHINGTON, DC, 20005, US

(21) Appl. No.: 10/475,220

(22) PCT Filed: Feb. 7, 2002
(86) PCT No.: PCT/KR02/00192

(30) Foreign Application Priority Data
Apr. 23, 2001 (KR) 2001/21831

(51) Int. Cl. G06F 17/00; G06F 19/00

(52) U.S. Cl. 463/6

(57) ABSTRACT

The present invention relates to a system and method for virtual reality game. More particularly, the system exploits a terminal, a server, and network connecting the terminal and the server together such as internet. An exercise machine connected to the above terminal enables users in various terminals connected to the server to exercise appreciating virtual or real images and have a race each other with permitting the same load with a real racing course by converting a load in accordance with a load condition of synthetic image comprising the user's avatar transmitted from the server to the terminal and an image of a racing course.

### TECHNICAL FIELD

The present invention relates to a system and method for a virtual reality game. More particularly, the system exploits a terminal, a server, and network connecting the terminal and the server together such as internet. An exercise machine connected to the above terminal enables users in various terminals connected to the server to exercise appreciating virtual or real images, and have a race each other with permitting the same load with a real racing course by converting a load in accordance with a load condition of synthetic image composing the user's avatar transmitted from the server to the terminal and an image of a racing course.

### BACKGROUND ART

Korean Laid-open Patent No. 2000-72390 (Patent Application No. 10-2000-51520) has disclosed a method for a virtual cycle race using a computer network, which enables several persons in various places to enjoy a cycle race simultaneously in cyber space by using a virtual reality, a sponsor company to advertise, and a spectator to make a bet.

Unfortunately, the conventional method for a virtual cycle race using a computer network in which the ordinary exercise machine is connected to common images has a problem lacking reality, because the load of displayed images and the exercise machine connected to a terminal do not operate together.

### BRIEF DESCRIPTION OF THE DRAWINGS

FIG. 1 represents the conceptional diagram of a system in one embodiment of the present invention;

FIG. 2 represents the flow diagram of data in one embodiment of the present invention;

FIG. 3 represents the flow chart in one embodiment of the present invention.

### EXPLANATION OF SYMBOLS IN THE FIGURES

10: terminal

12: image displaying module

14: load controlling module

16: information on a user's movement transmitting module

18: momentum displaying module

20: exercise machine

30: server

31: avatar database (DB)

32: virtual or real image database (DB)

33: load value database (DB)

34: information on a user's movement database (DB)

35: image synthesizing module

36: transmitting module

37: information on a user's movement saving module

40: network

### DISCLOSURE OF INVENTION

The present invention has tried to solve the disadvantages in the conventional technique described above. The object of the present invention is to provide a system for a virtual reality game and a method thereby which enables users of the exercise machine in various terminals connected to the server to exercise appreciating virtual or real images, exercise, and have a race each other while permitting the same load with a real racing course by converting a load in accordance with a load condition of synthetic image composing a user's avatar transmitted to the terminal and an image of a racing course.

The method for a virtual reality game of the present invention by using a system for a virtual race includes at least one terminal, exercise machine connected to the terminal, at least one server, and network connecting the terminal and the server each other.

The method for a virtual reality game of the present invention comprises;

image selecting stage in which a user selects a virtual or real image of a favorite race or a course; exercising stage in which a user has a race on the exercise machine; image displaying stage in which a synthetic image that an avatar of the user has a race in the virtual or real image is displayed on a displayer of the terminal; and a load approving stage in which a load value for each frame of the images is applied and approved to the exercise machine.

In addition, information displaying stage in which information on the user's movement is achieved and saved in the terminal or the server. Information on a user's movement is displayed on a displayer connected with the terminal. Moreover, more than two avatars are synthesized in the synthetic image of the image displaying stage.

Furthermore, the system for a virtual reality game of the present invention includes at least one terminal, an exercise machine connected to the terminal, at least one server, network connecting the terminal and the server each other.

The system for a virtual reality game of the present invention comprises: the server consisting in avatar DB in which the avatar of the user utilizing the exercise machine is saved; image DB in which a real designated race or course is recorded, or a virtual image of a race or course on a virtual space produced by a computer is saved; load value DB in which a load value on frames of the images with a fixed interval is saved; an image synthesizing module which composes a virtual or real image selected from the image DB with the avatar; and a transmitting module which sends a synthetic image produced by the image synthesizing module and a load value on frames of the images with a fixed interval to the terminal. The terminal consists of an image displaying module which displays the synthetic image transmitted from the transmitting module on a displayer of the terminal and a load controlling module which controls a load of the exercise machine by using the load value transmitted from the transmitting module. The exercise machine is composed of a load controller whose load is controlled by the load controlling module in the terminal.

Besides, a sensor measuring information on the user's movement is installed onto the exercise machine. The terminal is also equipped with information detecting module to detect the information on a user's movement achieved by the sensor, information transmitting module to send the information on a user's movement detected by the information detecting module to the server, and a momentum displaying module to receive the above information on a user's movement or information saved in following information on a user's movement DB and to display the information on the displayer in the terminal. The server includes information DB in which information on a user's movement is saved and information saving module which receives the information on a user's movement and saves the information to the information additionally. The transmitting module also has a function to transmit the information saved in the information on a user's movement DB to the terminal.

The information on a user's movement depicts one or more than two items selected among an exercise machine operating momentum, a user's weight, a user's momentum, a user's fat decomposition rate, a user's calorie consumption, a user's momentum of the past, and a user's desired target momentum.

The load value represents a weight based on one or more than two items selected among a surface slope of frames of the images with a fixed interval, strength and direction of wind, temperature, humidity, and landscape.

Preferably, the synthetic image in the image displaying stage is composed of more than two users' avatars synthesized.

The exercise machine depicts one or more than two items selected among a running machine, a cycle, a rowing machine, and a horse racing apparatus.

The recorded real image includes real people or animals having a race in practice.

The avatar has a feature that its figure is converted in accordance with the information on a user's movement.

The image or a designated frame of the image has a feature that the consumed calorie is displayed onto the images respectively and some pieces of frames are selected and compose a new image in accordance with a desired target momentum set in advance.

Hereinafter, the present invention will be clearly described in reference to the following drawings. However, it will be appreciated that those skilled in the art, on consideration of this disclosure, may make modifications and improvements within the scope of the present invention.

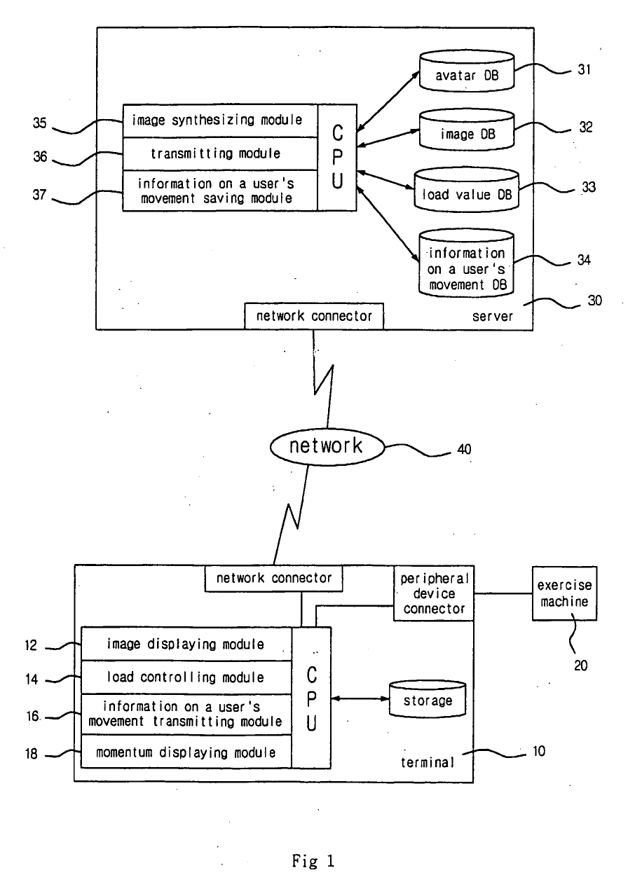

FIG. 1 represents the conceptional diagram of a system in one embodiment of the present invention.

As illustrated in FIG. 1, a system for a virtual reality game of the present invention comprises a terminal (10), an exercise machine (20) connected to the terminal (10), a server (30), and a network (40) connecting the terminal (10) and the server together.

Preferably, the terminal (10) can be various types of the terminal adopted from a computer, a mobile telecommunication terminal, PDA, Network Controller computer, or a network TV and more preferably, can be composed of a usual computer.

The terminal (10) is connected to the network (40) such as internet, phone access network, and LAN by using a network connector (not depicted) and also connected to the exercise machine (20) by using a peripheral device connector (not depicted). The exercise machine can be various types which are prepared with a running machine, a cycle, a rowing machine, or a horse racing apparatus.

In addition, the terminal (10) is equipped with an image displaying module (12), a load controlling module (14), information on a user's movement transmitting module (16) and a momentum displaying module (18).

The image displaying module (12) displays an image transmitted from the server (30) on a displayer in the terminal (10). The displayer can be prepared with an output apparatus such as a monitor and a printer of the terminal (10) and can be modified to a glasses-type displayer that a user wears on a head to display an image.

The load controlling module (14) controls a load of the exercise machine (20) by utilizing a load value of an image transmitted from the server (30). For example, in case that the exercise machine (20) is a cycle, a brake adding a load is installed onto the cycle to prevent a pedal from being worked easily when the image appearing on the displayer is an ascent. On the other hand, a motor is installed onto the cycle to enable a wheel to rotate without working a pedal when the image appearing on the displayer is a descent. The brake and the motor are controlled by the load controlling module (14) of the terminal (10).

The load value can be obtained by a weight based on one or more than two items selected from a surface slope of frames of the image with a fixed interval, strength and direction of wind, temperature, humidity, and a landscape. Preferably, the load value may use just the surface slope of frames of the image.

The information on a user's movement transmitting module (16) transmits information on a user's movement collected from various sensors (not depicted) installed onto the exercise machine (20) toward the server (30).

The sensors are usually installed onto the exercise machine (20) or occasionally attached directly onto the user's body.

The information on a user's movement transmitted to the server (30) is saved in DB, processed, transmitted again to the terminal (10), and finally displayed on the displayer of the terminal by the momentum displaying module (18). The information on a user's movement is displayed as a present state when a user utilizes the exercise machine (20) or as data of the whole movement state after a user finishes exercising or racing.

The information on a user's movement utilizes one or more than two items selected among exercise machine operating momentum, a user's weight, a user's momentum, a user's decomposition rate of body fat, a user's consumed calorie, a user's momentum of the past, and a user's targeted movement. The information on a user's movement can be measured indirectly by using an operating momentum of the exercise machine (20) and directly by installing the exercise machine onto a user's body. Preferably, the indirect method seems to be adopted since a user usually prefers measuring by a sensor installed on the exercise machine to attaching a sensor to the body itself.

The server (30) is connected to the network through a network connector (not depicted) and comprises avatar DB (31), virtual or real image DB (32), load value DB (33), information on a user's movement DB (34), image synthesizing module (35), transmitting module (36), and information on a user's movement saving module (37).

In the avatar DB (31), various kinds of avatars for nonmembers and distinctive avatars for each member are saved. The avatars can be corrected by a member's log-in and be dressed up by changing clothes, wearing ornaments or the like with paying cyber money.

Moreover, the avatars can convert body shapes at any time when a user loses weight by exercising and the like. The body shapes of avatars can be converted in the course of user's exercising and can be programmed to be converted by the information saved in the information on a user's movement DB (34). Especially, the change of an avatar's body shape is referred as a whole by using the information on a user's movement which is managed from the past in case that the user is a member.

In the virtual or real image DB (32), a real designated race or course is recorded or an image on a race or course on a virtual space drawn up by a computer is saved. The image can record a course in which a virtual race of the present invention is played or sometimes depict a recording of a real race, depending upon cases. Furthermore, the image can be in a real time that a real race is playing.

The image synthesizing module (35) composes an image selected by a user and a user's avatar or an avatar selected by a user in case that the user is not a member, if a signal to start an exercise or a race is transmitted from the terminal (10). The synthetic image obtained from the image synthesizing module (35) can be directly transmitted to the terminal (10) by the transmitting module (36) or transmitted to the terminal (10) by the transmitting module (36) after being saved temporarily to a synthetic image DB equipped in the server (30) separately.

The image composed by the image synthesizing module (35) can be selected by a user as described above, but it is possible to make automatically an image appropriate for the desired target momentum set in advance adopted.

Besides, consumed calories can be displayed respectively on the image or a piece of the image fragmented to sections.

Some pieces from the fragments of the image are chosen in accordance with a desired target momentum set in advance and can be prepared to make a new image in case that an image appropriate for the targeted momentum is selected automatically.

The targeted momentum is set in advance in case that a user is applied as a member, for instance, a targeted momentum such as weight reduction to 20 kg for a year. Meanwhile, it is supposed by calculating a present weight and consumed calorie on that day in case that a user is a non-member.

By the image synthesizing module (35), several avatars corresponding to several users can be synthesized with the image in case that the user has a race. At this moment, it is preferred that the image synthesizing module (35) produces a synthetic image corresponding to each avatar, which is located in the center of the synthetic image, and the transmitting module (36) transmits respective synthetic image to the terminal (10) of respective host user of the corresponding avatar.

In the load value DB (33), a load value for frames of each image in the virtual or real image DB (32) with a designated interval is recorded. In case that the load value of the load value DB (33) is simultaneously recorded in the image DB (32), the load value DB (33) can be omitted.

In the information on a user's movement DB (34), information from the terminal (10) is saved. The information on a user's movement is whether the first data on movement detected from the exercise machine (20) or data processing the first data in the terminal (10) or the server (30).

By the information on a user's movement saving module (37), the information from the terminal is saved toward the information on a user's movement DB (34).

Through the transmitting module (36), the synthetic image composed by the image synthesizing module (35), the information on a user's movement or the like are transmitted to the terminal (10).

The network (40) connects the terminal (10) and the server (30). Generaly, the network is prepared as a form such as internet, phone communication network with wired or wireless, LAN, or combination of the above.

It is preferable that the image displaying module (12), the load controlling module (14), the information on a user's movement transmitting module (16), and the momentum displaying module (18) are installed onto the terminal (10), and that the avatar DB (31), the virtual or real image DB (32), the load value DB (33), the information on a user's movement DB (34), the image synthesizing module (35), the transmitting module (36), and the information on a user's movement saving module (37) are installed onto the server (30). However, the above members are possible to be installed onto the other portion, depending upon cases. For example, all of the above DBs and modules can be installed onto the terminal, and the server (30) and, the network (40) can be omitted. On the other hand, all of the above DBs and modules are installed on the server (30) and the terminal (10) can be composed of just a monitor. Moreover, the avatar DB (31) is possible to be equipped on the terminal (10).

Besides, the above DBs and modules are often combined, added with other components, or removed in accordance with a need. Especially, the information on a user's movement transmitting module (16), the momentum displaying module (18), the information on a user's movement DB (34), the information on a user's movement saving module (37) and the like can be omitted, unless the information on a user's movement is searched and displayed.

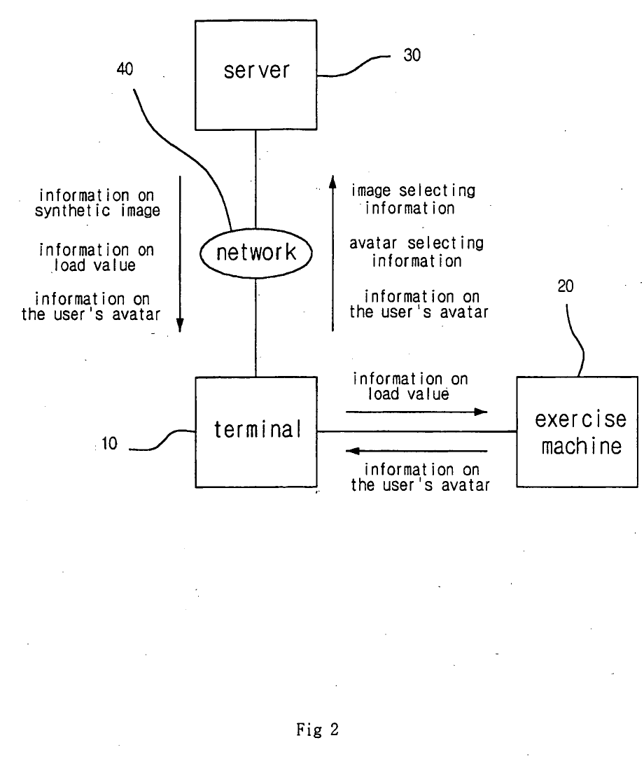

FIG. 2 represents the flowing diagram of data in one embodiment of the present invention.

As illustrated in FIG. 2, the terminal (10) receives information on a synthetic image and a load value from the server (30), displays the synthetic image on the displayer (not depicted) of the terminal, and transmits the information on a load value or a controlling signal in accordance with the information on a load value to the exercise machine (20) in order to control the exercise machine. In addition, the terminal transmits the information on a user's movement from the exercise machine (20) to the server (30), receives again the information on a user's movement processed by the server (30), and displays the information on the displayer (not depicted). Besides, an image selecting information and an avatar selecting information are transmitted from the terminal (10) to the server (30) in the initial stage of a race or an exercise.

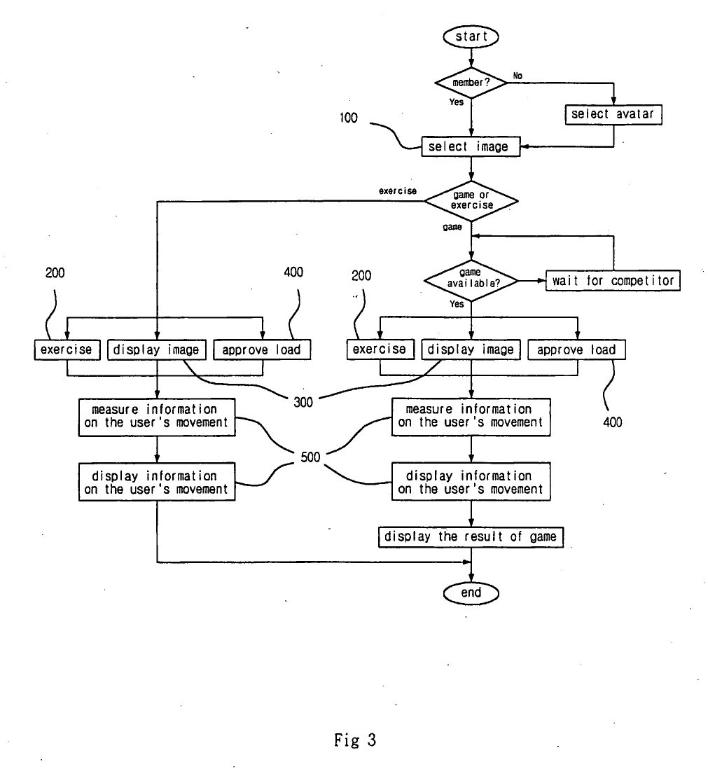

FIG. 3 represents the flow chart in one embodiment of the present invention.

As illustrated in FIG. 3, a user inputs whether to be a member or not before utilizing the exercise machine (20). In case that the user is a non-member, an avatar is selected from a lot of avatars in the avatar DB (31) of the server. In case that the user is identified as a member, an avatar corresponding to the member which is saved in the avatar DB (31) of the server (30) is selected.

Next, the user selects a favorite virtual or real image (image selecting stage: 100). The image can be often chosen by a user in the image selecting stage (100), but an image appropriate for the desired target momentum set in advance is automatically selected in case that the user is a member, depending upon the target momentum. Although a user is a non-member, the user can automatically choose a proper image based on a weight, a desired target momentum and the like.

In the following step, the user determines whether to play a race or to exercise.

In case that the user decides to play a race, he/she passes to the next stage if a race is available or waits for a competitor or until a race becomes possible if a race is not prepared.

The user exercises on the exercise machine (20) (exercising stage: 200), and a synthetic image is displayed on a displayer of the terminal (10) (an image displaying stage: 300). Simultaneously, a load is approved to the exercise machine (20) (a load approving stage: 400).

While the user exercises on the exercise machine (20), the information on a user's movement is measured by sensors attached onto the exercise machine (20) and transmitted to the server (30). The information is displayed on the displayer of the terminal (10) during or after exercising (information on a user's movement displaying stage: 500).

In case that a race is processed through the above stages, a result of the race is additionally displayed on the displayer, and then the whole system is finished.

### Industrial Applicability

As demonstrated and confirmed above, in the present invention, when a user of an exercise machine exercises with appreciating a virtual or real image or the users have a race together, they can enjoy exercising or playing in a condition same with or similar to a real surrounding by approving the same load with a real exercising course or a real racing course to the exercise machine.

What is claimed is:

1. A method for a virtual reality game, which is made by a system for a virtual reality game including at least one terminal, an exercise machine connected to the terminal, at least one server, network connecting the terminal and the server each other: which comprises,
image selecting stage wherein a user selects an image of a favorite race or a course;
exercising stage wherein a user exercises on the exercise machine;
image displaying stage wherein a synthetic image that the user's avatar exercises or has a race on the image is displayed on a displayer of the terminal; and,
load approving stage wherein a load value for each frame of the image is applied to and approved to the exercise machine.

2. The method for a virtual race according to claim 1, which additionally has information on a user's movement displaying stage wherein the user's information on a user's movement is measured and saved in the terminal or the server, and then the information is displayed on the displayer connected with the terminal.

3. The method for a virtual reality game according to claim 1 or claim 2, in which the synthetic image appearing in the image displaying stage is composed of more than two users' avatars.

4. A system for a virtual reality game, which includes at least one terminal, an exercise machine connected to the terminal, at least one server, network connecting the terminal and the server each other: which comprises;
the server composed of an avatar DB where a user's avatar is saved; a virtual or real image DB where a designated race or a course is recorded, or an image on a race or a course in a virtual space produced by a computer is saved; a load value DB where a load value for frames of the image in a designated interval is saved; an image synthesizing module which composes an image selected from the image DB and the avatar; and a transmitting module which transmits the synthetic image by the image synthesizing module and the load value for frames of the image in a designated interval to the terminal;
the terminal consisting of an image displaying module which displays the synthetic image transmitted by the transmitting module on the displayer of the terminal; and a load controlling module which controls a load value of the exercise machine by using a load value transmitted by the transmitting module; and,
the exercise machine consisting of a load, controller whose load is controlled by the load controlling module of the terminal.

5. The system for a virtual race according to claim 4, which comprises;
the exercise machine which is additionally equipped with a sensor to measure the information on a user's movement;
the terminal which is additionally equipped with information on a user's movement detecting module to detect the information measured by the sensor, information on a user's movement transmitting module to transmit the information detected by the information on a user's movement detecting module to the server, and a momentum displaying module to receive the above information or information saved in following information on a user's movement DB and to display the information on the displayer of the terminal; and,
the server which is additionally equipped with information on a user's movement DB in which the information on a user's movement is saved and information on a user's movement saving module which receives the information on a user's movement, saves the information to the information on a user's movement DB, and transmits the information on a user's movement saved in the information on a user's movement DB to the terminal.

6. The system for a virtual reality game according to claim 5, in which the information on a user's movement depicts one or more than two items selected among exercise machine operating momentum, a user's weight, a user's momentum, a user's decomposition rate of body fat, a user's consumed calorie, a user's momentum of the past, and a user's desired target momentum.

7. The system for a virtual reality game according to one claim between claim 4 and claim 6, in which the load value depicts a weight based on one or more than two items selected among a surface slope of frames of the image in a fixed interval, strength and direction of wind, temperature, humidity, and a landscape.

8. The system for a virtual reality game according to claim 7, in which more than two users' avatars are composed to the synthetic image in the image displaying stage.

9. The system for a virtual reality game according to claim 7, in which the exercise machine depicts one or more than two items selected among a running machine, a cycle, a rowing machine, and a horse racing equipment.

10. The system for a virtual race according to claim 7, in which the recorded image selected from the images includes real people or animals having a race in practice

11. The system for a virtual reality game according to claim 7, in which the avatar has a feature that its body shape is converted in accordance with the information on a user's movement.

12. The system for a virtual reality game according to claim 7, in which the consumed calorie is displayed on the image or a designated fragment of the image and some pieces collected from the fragments produce a new image in accordance with a desired target momentum set in advance.
